(19) United States
(12) Patent Application Publication
(10) Pub. No.: US 2007/0223405 A1
(43) Pub. Date: Sep. 27, 2007

(54) Method and apparatus for activating hybrid automatic repeat request process in a wireless communications system

(75) Inventors: Sam Shiaw-Shiang Jiang, Taipei City (TW); Li-Chih Tseng, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: Innovative Sonic Limited

(21) Appl. No.: 11/727,188

(22) Filed: Mar. 23, 2007

Related U.S. Application Data
(60) Provisional application No. 60/743,676, filed on Mar. 23, 2006.

(51) Int. Cl. H04B 7/005; H04Q 7/00

(52) U.S. Cl. 370/278; 370/329

(57) ABSTRACT

A method for activating a first Hybrid Automatic Repeat Request (HARQ) process used in a mobile of a wireless communications system includes receiving a first Primary Absolute Grant (AG) message indicating to activate the first HARQ process, and only activating the first HARQ process and de-activating all HARQ processes other than the first HARQ process.

### CROSS REFERENCE TO RELATED APPLICATIONS

This application claims the benefit of U.S. Provisional Application No. 60/743,676, filed on Mar. 23, 2006 and entitled “Method and Apparatus for Activating First HARQ Process,” the contents of which are incorporated herein by reference.

### BACKGROUND OF THE INVENTION

1. Field of the Invention

The present invention relates to HARQ process activation in wireless communications systems, and more particularly to a method and related apparatus for reducing inter-mobile interference and signaling overhead, and avoiding radio resource waste.

2. Description of the Prior Art

The third generation (3G) mobile telecommunications system has adopted a Wideband Code Division Multiple Access (WCDMA) wireless air interface access method for a cellular network. WCDMA provides high frequency spectrum utilization, universal coverage, and high quality, high-speed multimedia data transmission. The WCDMA method also meets all kinds of QoS requirements simultaneously, providing diverse, flexible, two-way transmission services and better communication quality to reduce transmission interruption rates. Through the 3G mobile telecommunications system, a user can utilize a wireless communications device, such as a mobile phone, to realize real-time video communications, conference calls, real-time games, online music broadcasts, and email sending/receiving. However, these functions rely on fast, instantaneous transmission. Thus, targeting third generation mobile telecommunication technology, the prior art provides High Speed Downlink Package Access (HSDPA) and High Speed Uplink Package Access (HSUPA), which are used to increase bandwidth utility rate and package data processing efficiency to improve uplink/downlink transmission rate.

HSUPA increases upstream network performance, reduces transmission delay by rapid retransmission of erroneous data transmissions, and can adjust transmission rate based on channel quality. To realize this type of “power control,” HSUPA adopts technologies such as NodeB Scheduling, Hybrid Automatic Repeat Request (HARQ), Soft Handover, and Short Frame Transmission. Correspondingly, the 3rd Generation Partnership Project (3GPP) defines an Enhanced Dedicated Transport Channel (E-DCH) for controlling operations of HSUPA. E-DCH introduces new physical layer channels, such as E-HICH, E-RGCH, E-AGCH, E-DPCCH, and E-DPDCH, which are used for transmitting HARQ ACK/NACK, Uplink Scheduling Information, Control Plane information, and User Plane information. Detailed definitions of the above can be found in the Medium Access Control (MAC) protocol specification, “3GPP TS 25.321 V6.7.0,” and are not given here.

Through Short Frame Transmission technology, HSUPA can configure 2 ms or 10 ms Transmit Time Interval (TTI), and the number of HARQ processes depends on the TTI durations. According to section 11.8.1.1.1 of the aforementioned MAC protocol specification, the number of HARQ processes is equal to the HARQ Round Trip Time (RTT), which is the time duration between the instant when a signaling is sent out and the instant when a response message is received. For 2 ms (millisecond) TTI, the HARQ RUT is equal to 8 TTIs, so the number of HARQ processes is equal to 8. For 10 ms TTI, the HARQ RTT is equal to 4 TTIs, so the number of HARQ processes is equal to 4.

In addition, through NodeB Scheduling technology, a base station (Node B) is allowed to adjust transmission power of mobiles or user equipments (UEs) within its transmission range (cell), so as to control uplink transmission rate of the mobiles. Referring to sections 9.2.5.2.1 and 9.2.5.2.2 of the aforementioned MAC protocol specification, the network can provide Relative Grant (RG) messages and Absolute Grant (AG) messages to a mobile through an E-DCH Relative Grant Channel (E-RGCH) and an E-DCH Absolute Grant Channel (E-AGCH) respectively, so as to adjust the transmission grant of the mobile. The E-AGCH is a shared channel that use an E-DCH Radio Network Temporary Identifier (E-RNTI) in order to address the AG messages to specific mobiles. The AG messages are used to directly adjust the transmission grant of mobiles, and can be classified into two types, Primary and Secondary. The Primary AG message provides an uplink resource grant for a specified mobile served by a cell. The Secondary AG message provides an uplink resource grant for a group of mobiles served by the cell, so as to reduce signaling overhead. On the other hand, the AG message includes an AG value field and an AG Scope field. The AG value field indicates the transmission resource the mobile is allowed to use in the next transmission. The AG Scope field indicates that the applicability of the AG value is “Per HARQ process” or “All HARQ Processes,” meaning whether the AG value field will affect one or all HARQ processes.

According to section 11.8.1.3.1 of the aforementioned MAC protocol specification, after a mobile receives an AG message, if the E-RNTI type is “Primary,” the AG value is set to “INACTIVE,” the AG Scope is “Per HARQ process,” and a 2 ms TTI is configured, then the mobile shall de-activate a current HARQ process, which is the process identified by the value of a variable CURRENT_HARQ_PROCESS. If the E-RNTI type is “Primary,” the AG value is set to “INACTIVE,” the AG Scope is “All HARQ processes,” and a secondary E-RNTI was configured by higher layers, then the mobile shall activate all HARQ processes, set Serving Grant (SG) value to stored secondary grant (Serving_Grant=Stored_Secondary_Grant), and set a primary grant state variable to “none” (Primary_Grant_Available=false), meaning that the SG value can be affected by Secondary AG messages.

Besides, if the AG value is different from “INACTIVE,” and the E-RNTI type is “Secondary,” then the mobile shall set the variable Stored_Secondary_Grant to the AG value. Oppositely, if the E-RNTI type is “Primary” or the variable Primary_Grant_Available is set to “False,” then the mobile shall set the SG value to the AG value (Serving_Grant=AG value). Meanwhile, if the E-RNTI type is “Primary,” then the mobile shall set the variable Primary_Grant_Available to “True.” Note that, definitions of “INACTIVE,” “Stored_Secondary_Grant,” “Primary_Grant_Available,” and “Serving_Grant” can be found in section 3.1.2 of the aforementioned MAC protocol specification.

Therefore, when all HARQ processes are de-activated by the Primary AG message, the mobile can use the transmission grant provided by the Secondary AG message. When the Secondary AG message affects a mobile (to set its SG value), only the AG value “All HARQ processes” is valid in the AG Scope filed and all processes are activated. At the same time, if the previous AG message that affected the mobile was the Primary one, the variable Primary_Grant_Available would be set to “False” from “True,” or if previous AG message was the Secondary one, the variable Primary_Grant_Available would remain “False.” When the Primary AG message affects the mobile, if the previous AG message that affected the mobile was the Primary one, the variable Primary_Grant_Available would remain “True,” or if the previous AG message was the Secondary one, the variable Primary_Grant_Available would be set to “True” from “False.”

As mentioned above, the Primary AG message provides the uplink resource grant for a specific mobile. Therefore, when the AG message that is received by a mobile transfers its type from “Secondary” to “Primary,” it means that the Serving cell permits the mobile to start transmitting data in the corresponding data rate for different services. The Primary AG message provided by the serving cell can control data transmission rate for a single HARQ process or for all HARQ processes through the AG Scope indicating “Per HARQ process” or “ALL HARQ process” respectively.

In addition, according to section 11.8.1.3.1 of the aforementioned MAC protocol specification, when the variable Primary_Grant_Available is “False” and a mobile receives the Primary AG message that its AG Scope is “Per HARQ process” and its AG value is different from “INACTIVE,” the prior art simply activates the corresponding process and takes no action on other processes. In fact, if the variable Primary_Grant_Available is “False”, it means that the last AG message that affected the mobile was the Secondary one and all HARQ processes would be activated. For example, please refer to FIG. 1, which is a schematic diagram of variation of the SG value of a mobile in response to a Secondary AG message SAG and a Primary AG message PAG. In FIG. 1, the first row represents HARQ process identification numbers HARQ_ID, the second row represents the SG values with Arabic numerals, and “X” represents that the corresponding HARQ process is “INACTIVE.” At time point T, the mobile receives the Primary AG message PAG that its AG Scope field is “Per HARQ process” and its AG value is 3, such that after time point T, the transmission grants for all HARQ processes of the mobile are 3. In this situation, there are two drawbacks in the prior art:

1. Coarse scheduling granularity. Specifically speaking, the serving cell cannot schedule the mobile down to one single process through a single Primary AG message. The only way the prior art can achieve single process grant is activating all processes with one Primary AG message and then sending other (seven) Primary AG messages to de-activate one process each time.

2. Even if the granularity is appropriate, all the HARQ processes of the mobiles, say eight of them, under the Primary AG message control are active. Thus, the serving cell would receive data from these eight mobiles in each TTI in a mixed style. Comparing to schedule each mobile to use each process with eight-folded grant in a separate style, the total transmission power is same for both styles while the mixed style has higher interference between mobiles than the separate style. Besides, one signaling traffic (ACK/NACK) would be transmitted for each mobile in every TTI, i.e. eight ACK/NACK signals per TTI in the mixed style. For the separate style, only one ACK/NACK signal per TTI is needed.

### SUMMARY OF THE INVENTION

According to the present invention, a method for activating a first Hybrid Automatic Repeat Request (HARQ) process used in a mobile of a wireless communications system comprises receiving a first Primary Absolute Grant (AG) message indicating to activate the first HARQ process, and only activating the first HARQ process and de-activating all HARQ processes other than the first HARQ process.

According to the present invention, a communications device of a wireless communications system utilized for activating a first Hybrid Automatic Repeat Request (HARQ) process to avoid radio resource waste comprises a control circuit for realizing functions of the communications device, a processor installed in the control circuit for executing a program code to operate the control circuit, and a memory coupled to the processor for storing the program code. The program code comprises receiving a first Primary Absolute Grant (AG) message indicating to activate the first HARQ process, and only activating the first HARQ process and de-activating all HARQ processes other than the first HARQ process.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of variation of the SG value of a mobile in response to a Secondary AG message and a Primary AG message according to the prior art.

FIG. 2 is a function block diagram of a wireless communications device.

FIG. 3 is a diagram of program code of FIG. 1.

FIG. 4 is a flowchart of a process according to the embodiment of the present invention.

FIG. 5 is a schematic diagram of variation of the SG values of mobiles according to the process of FIG. 4.

### DETAILED DESCRIPTION

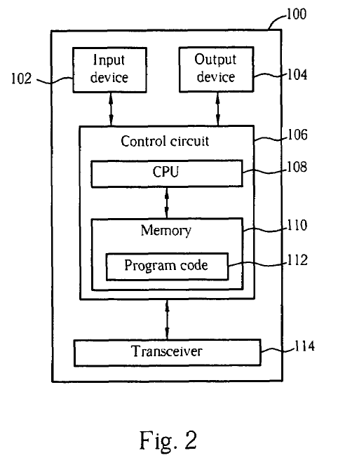

Please refer to FIG. 2, which is a functional block diagram of a communications device 100. For the sake of brevity, FIG. 2 only shows an input device 102, an output device 104, a control circuit 106, a central processing unit (CPU) 108, a memory 110, a program code 112, and a transceiver 114 of the communications device 100. In the communications device 100, the control circuit 106 executes the program code 112 in the memory 110 through the CPU 108, thereby controlling an operation of the communications device 100. The communications device 100 can receive signals input by a user through the input device 102, such as a keyboard, and can output images and sounds through the output device 104, such as a monitor or speakers. The transceiver 114 is used to receive and transmit wireless signals, delivering received signals to the control circuit 106, and outputting signals generated by the control circuit 106 wirelessly. From a perspective of a communications protocol framework, the transceiver 114 can be seen as a portion of Layer 1, and the control circuit 106 can be utilized to realize functions of Layer 2 and Layer 3. Preferably, the communications device 100 is utilized in a third generation (3G) mobile communications system.

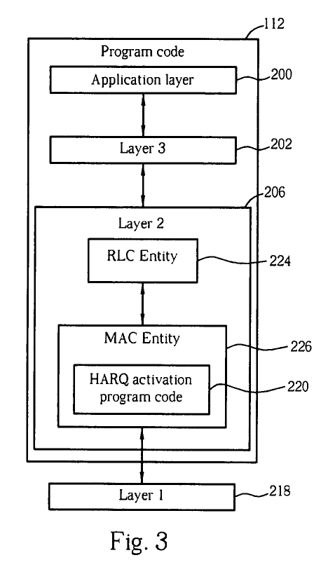

Please continue to refer to FIG. 3. FIG. 3 is a diagram of the program code 112 shown in FIG. 2. The program code 112 includes an application layer 200, a Layer 3 202, and a Layer 2 206, and is coupled to a Layer 1 218. The Layer 2 206 comprises two sub-layers: a radio link control (RLC) entity 224 and a media access control (MAC) entity 226. A primary function of the RLC entity 224 is providing different transmission quality processing, performing segmentation, reassembly, concatenation, padding, retransmission, ciphering, sequence check, and duplication detection on transmitted data or control instructions based on different transmission quality requirements. The MAC entity 226 can match packets received from different logic channels of the RLC entity 224 to common, shared, or dedicated transport channels according to radio resource allocation commands of the Layer 3 (RRC layer) 202, for performing channel mapping, multiplexing, transport format selection, or random access control.

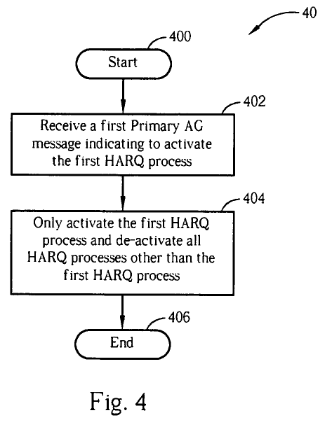

In some applications, such as when realizing high-speed uplink packet access (HSUPA) functions, the MAC entity 226 can activate HARQ processes according to a Primary AG message provided by the network. In this situation, the embodiment of the present invention provides an HARQ activation program code 220 utilized for timely activating HARQ processes, in order to avoid radio resource waste, and reduce unnecessary transmissions. Please refer to FIG. 4, which is a flowchart diagram of a process 40 according to the embodiment of the present invention. The process 40 is utilized in a mobile of the wireless communications system for activating a first HARQ process, and can be complied into the HARQ activation program code 220. The first HARQ process is preferably the current HARQ process of the mobile. The process 40 comprises the following steps:

Step 400: Start.

Step 402: Receive a first Primary AG message indicating to activate the first HARQ process.

Step 404: Only activate the first HARQ process and de-activate all HARQ processes other than the first HARQ process.

Step 406: End.

According to the process 40, after the mobile receives the Primary AG message from the serving cell, the mobile only activates the current HARQ process, which is the process identified by the value of the variable CURRENT_HARQ_PROCESS, with the transmission grant provided by the Primary AG message, and de-activates other HARQ processes. In other words, when the HARQ process given by the value of CURRENT_HARQ_PROCESS is activated by a Primary AG message and the AG Scope is “Per HARQ process” while the variable Primary_Grant_Available is “False,” the mobile de-activates all HARQ processes other than the HARQ process given by the value of the variable CURRENT_HARQ_PROCESS.

Therefore, with the process 40, the serving cell can easily schedule a mobile down to a single process so that served mobiles can operate in separate style, i.e. each mobile uses process of different TTI. Inter-mobile interference and ACK/NACK signaling would be reduced compared to the mixed style operation, so as to reduce signaling overhead of the network and avoid radio resource waste.

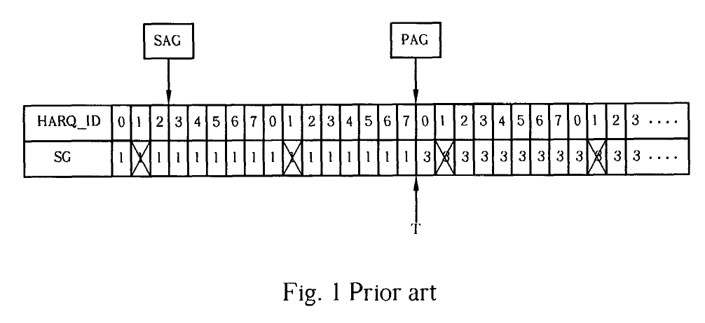

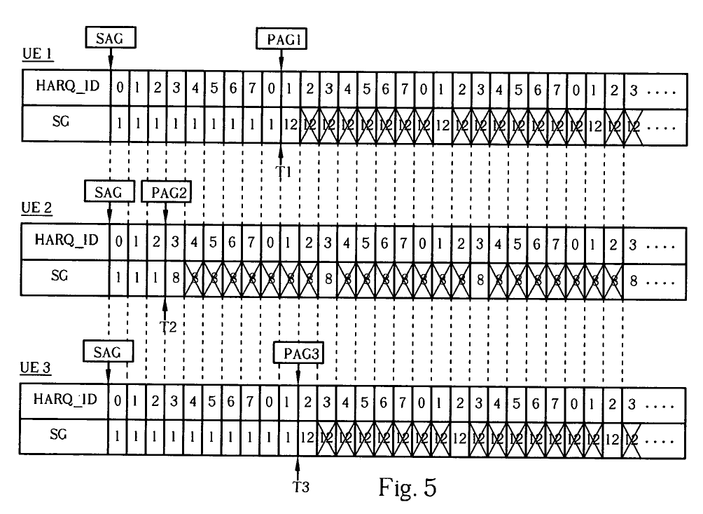

For example, please refer to FIG. 5, which is a schematic diagram of variation of the SG values of mobiles UE1, UE2, and UE3 according to the process 40. Like FIG. 1, “HARQ_ID” represents the HARQ process identification numbers, “SG” represents the SG values by Arabic numerals, and “X” represents that the corresponding HARQ process is “INACTIVE.” At time point T1, the mobile UE1 receives the Primary AG message PAG1 that its AG Scope field is “Per HARQ process” and its AG value is 12, such that according to the process 40, the mobile UE1 only activates the current HARQ process, which is the process having HARQ_ID equal to 1, by the transmission grant provided by the Primary AG message PAG1, and the mobile UE1 de-activate other HARQ processes. By the same token, after time point T2, the mobile UE2 only activates the current HARQ process, which is the process having HARQ_ID equal to 3, by the transmission grant provided by the Primary AG message PAG2. After time point T3, the mobile UE3 only activates the current HARQ process, which is the process having HARQ_ID equal to 2, by the transmission grant provided by the Primary AG message PAG3.

In summary, with the embodiment of the present invention, when the HARQ process given by the value of CURRENT_HARQ_PROCESS is activated by a Primary AG message and the AG Scope is “Per HARQ process” while the variable Primary_Grant_Available is “False,” the mobile de-activates all HARQ processes other than the HARQ process given by the value of the variable CURRENT_HARQ_PROCESS. Therefore, the serving cell can easily schedule a mobile down to a single process so that served mobiles can operate in separate style, so as to reduce signaling overhead of the network and avoid radio resource waste.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for activating a first Hybrid Automatic Repeat Request (HARQ) process used in a mobile of a wireless communications system comprising:
receiving a first Primary Absolute Grant (AG) message indicating to activate the first HARQ process; and
only activating the first HARQ process and de-activating all HARQ processes other than the first HARQ process.

2. The method of claim 1, wherein the first HARQ process is a current HARQ process of the mobile.

3. The method of claim 1, wherein the HARQ process uses transmission grants provided by the first Primary AG message.

4. The method of claim 1, wherein a 2 ms transmission time interval is configured.

5. The method of claim 1, wherein an AG value of the first Primary AG message is different from “INACTIVE”, and an AG Scope of the first Primary AG message is “Per HARQ process”.

6. The method of claim 5, wherein a variable Primary_Grant_Available is set to “False”, representing that there is no previous AG value set by previous primary AG message.

7. The method of claim 1, wherein the wireless communications system is a high speed uplink packet access system of a third generation (3G) mobile communications system.

8. A communications device of a wireless communications system utilized for activating a first Hybrid Automatic Repeat Request (HARQ) process to avoid radio resource waste comprising:
a control circuit for realizing functions of the communications device;
a processor installed in the control circuit for executing a program code to operate the control circuit; and
a memory coupled to the processor for storing the program code;
wherein the program code comprises:
receiving a first Primary Absolute Grant (AG) message indicating to activate the first HARQ process; and
only activating the first HARQ process and de-activating all HARQ processes other than the first HARQ process.

9. The communications device of claim 8, wherein the first HARQ process is a current HARQ process of the mobile.

10. The communications device of claim 8, wherein the HARQ process uses transmission grants provided by the first Primary AG message.

11. The communications device of claim 8, wherein a 2 ms transmission time interval is configured.

12. The communications device of claim 8, wherein an AG value of the first Primary AG message is different from “INACTIVE”, an AG Scope of the first Primary AG message is “Per HARQ process”.

13. The communications device of claim 12, wherein a variable Primary_Grant_Available is set to “False”, representing that there is no previous AG value set by previous primary AG message.

14. The communications device of claim 8, wherein the wireless communications system is a high speed uplink packet access system of a third generation (3G) mobile communications system.
